(19) United States
(12) Patent Application Publication
(10) Pub. No.: US 2008/0216257 A1
(43) Pub. Date: Sep. 11, 2008

(54) TOOTHBRUSH HAVING A PLURALITY OF REPLACABLE HEADS CONFIGURED TO CLEAN A PLURALITY OF ORAL SURFACES SIMULTANEOUSLY

(76) Inventors: Mitra Ahadpour, Jacksonville, FL (US); Farhad Bagheri, Jacksonville, FL (US)

Correspondence Address: MARK YOUNG, P.A., 12086 FORT CAROLINE ROAD, UNIT 202, JACKSONVILLE, FL, 32225, US

(21) Appl. No.: 11/684,322

(22) Filed: Mar. 9, 2007

(51) Int. Cl. A46B 13/00; A46B 9/04; A61C 17/00

(52) U.S. Cl. 15/22.1; 15/167.2; 433/143

(57) ABSTRACT

A toothbrush has a plurality of replaceable cleaning heads configured to clean a plurality of teeth surfaces simultaneously. The cleaning heads may be configured to clean one row of teeth at a time or bottom and top teeth simultaneously. In a configuration for cleaning bottom and top teeth simultaneously, the cleaning heads for the top teeth are movably offset from the cleaning heads for the bottom teeth to accommodate occlusion. The toothbrush may be manual or electrical. Accessories such as a tongue and cheek scraper and tooth pick are available.

### FIELD OF THE INVENTION

This invention relates generally to oral hygiene, and, more particularly, to a toothbrush having a plurality of replaceable heads and accessories configured to clean a plurality of oral surfaces simultaneously, and to provide an adjustable offset to accommodate unevenness of the top and bottom teeth.

### BACKGROUND

As toothbrush users are well aware, a crucial part of their dental hygiene regimen involves removing trapped food particles and plaque that build up in the mouth. A conventional toothbrush comprises a handle with a brushing head having a plurality of bristles that are used in conjunction with a dentifrice. Brushing with a conventional toothbrush is laborious, tedious, inefficient and conducive to error. The user positions the toothbrush bristles over a zone of the teeth, and then uses very short, rapid scrubbing strokes over the zone where the brush bristles have been located. This short-stroke brushing should continue for a period of time so as to remove any foreign material from that zone. The brush is then repositioned to clean another zone. Top surfaces, front surfaces and back surfaces of teeth comprise separate distinct zones. Because each zone is relatively small and all zones must be brushed using rapid short strokes, the technique is laborious, tedious, inefficient and requires excellent muscle control.

A development that has occurred in respect of manual toothbrushes is the provision of multi-headed brushes, whereby the several surfaces of the teeth can be cleaned using the bristles of the brush at the same time, with the same stroking action of the brush. By way of example, U.S. Pat. No. 5,305,491 to Hegemann, Apr. 26, 1994, discloses a toothbrush having three brush heads that self-adjust to maintain contact with the surfaces of the teeth and the gums. The three brush heads are independently attached to a single handle through elongated flexible arms and adjust independently to maintain contact with the surfaces of different size teeth and gums. The two brush heads whose bristles contact the sides of the teeth are slanted at a predetermined angle. Unfortunately, no provision is made for removal of each brush head. Additionally, the toothbrush is not configurable to simultaneously engage bottom and top teeth.

As another example, U.S. Pat. No. 6,209,164 to Sato, Apr. 3, 2001, discloses a toothbrush that includes an elongated grip handle having a plurality of toothbrush bodies mounted on the end. The toothbrush bodies are adapted to clean various surfaces of the teeth simultaneously. Unfortunately, again, no provision is made for removal of each brush head without the corresponding handle. The toothbrush is also not configurable to simultaneously engage bottom and top teeth. Furthermore, this toothbrush is bulky and likely to cause discomfort to areas inside the mouth.

While a few toothbrushes have been devised to clean bottom and top teeth surfaces simultaneously, they do not accommodate occlusion of the top and bottom teeth. For example, the toothbrush depicted in U.S. Design Pat. No. D325,821, to Schwartz, May 5, 1992, and the brush described in U.S. Pat. No. 3,732,589, to Burki, May 15, 1973, have brushing surfaces intended to clean top and bottom teeth simultaneously. However, the prior art devices do not properly offset the bottom and top brushing surfaces to accommodate unevenness of the top and bottom teeth. The top teeth of most individuals extend outwardly more than their bottom teeth and touch the cheek. Additionally, such brushes are difficult or impossible to utilize if a user wants to brush only one row of teeth at a time. Because of their bulkiness, they are also difficult to use for their intended purposes, i.e., brushing top and bottom surfaces. Furthermore, the brush heads are not removable.

Moreover, none of the multi-headed prior art brushes include accessories for cleaning the tongue, cheeks and between teeth. Specifically, none includes an integrated tongue and cheek scraper or a retractable pick.

The invention is directed to overcoming one or more of the problems and solving one or more of the needs as set forth above.

### SUMMARY OF THE INVENTION

To solve one or more of the problems set forth above, in an exemplary implementation of the invention, In one embodiment, an exemplary oral surface cleaning apparatus features a handle having distal and proximal ends and a cleaning assembly attached to the distal end of the handle. The cleaning assembly is configured to simultaneously clean a plurality of oral surfaces. The cleaning assembly may be permanently or releasably attached to the handle. The cleaning assembly comprises at least one brush head releasably attached to the distal end of the handle. In one exemplary embodiment at least one central brush head and one or a pair of lateral brush heads are provided. In another exemplary embodiment, the cleaning assembly comprises four brush heads.

In another embodiment, the cleaning apparatus is equipped with integrated cleaning accessories. For example, a scraper may be attached near the distal end of the handle. Additionally, a retractable pick may be operably coupled to the handle.

The apparatus may be manual or electrically operated. In the latter case, the handle houses an electrically powered actuator operably configured to cause motion of the cleaning assembly.

In another embodiment, means for releasably attaching a first cleaning implement to a second cleaning implement are provided on the handles of the cleaning implements. Thus, the assembly of cleaning implements enables brushing of top and bottom row oral surfaces simultaneously. The cleaning assembly of each implement may be permanently or releasably attached to the implement.

In one embodiment, the means for releasably attaching the each cleaning implement to the other may include a forward pivoting coupling having a forward female aperture and a corresponding forward male projection, and a rearward pivoting coupling having a rearward female aperture and a corresponding rearward male projection, with the forward pivoting coupling being disposed on the handle between the distal end and the rearward pivoting coupling, and the rearward pivoting coupling being disposed on the handle between the proximal end and the forward pivoting coupling. Such means are configured to engage each other with the forward male projection of the second implement engaging the forward female aperture of the first implement, and the forward male projection of the first implement engaging the forward female aperture of the second implement, and the rearward male projection of the second implement engaging the rearward female aperture of the first implement, and the rearward male projection of the first implement engaging the rearward female aperture of the second implement, an the means for releasably attaching the first cleaning implement and the means for releasably attaching the second cleaning implement are configured to allow longitudinal movement of the first implement relative to the second implement when the first implement is releasably attached to the second implement. Such an arrangement accommodates lateral, longitudinal and pivoting movement while the first implement and second implement are attached. Thus, the assembly may be readily adjusted to accommodate various bite patterns and occlusions while in use. The first cleaning assembly being configured to simultaneously clean a plurality of oral surfaces including oral surfaces of the top row of teeth, while the second cleaning assembly is configured to simultaneously clean a plurality of oral surfaces including oral surfaces of the bottom row of teeth.

In another embodiment, the cleaning assembly is equipped with integrated cleaning accessories. For example, a scraper may be attached near the distal end of a handle. Additionally, a retractable pick may be operably coupled to a handle.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a top perspective view of an exemplary toothbrush having a plurality of replaceable cleaning heads configured to scrub a plurality of teeth and gum surfaces simultaneously according to principles of the invention; and

FIG. 2 is a bottom perspective view of an exemplary toothbrush having a plurality of replaceable cleaning heads configured to scrub a plurality of teeth and gum surfaces simultaneously according to principles of the invention; and

FIG. 3 is a perspective view of an exemplary replaceable cleaning head for a toothbrush according to principles of the invention; and

FIG. 4 is a perspective view of an exemplary pair of toothbrushes, each having a plurality of replaceable cleaning heads configured to scrub a plurality of teeth and gum surfaces simultaneously, and each toothbrush being configured to movably engage and interlock the other according to principles of the invention; and

FIG. 5 is a front view of an exemplary pair of toothbrushes, each having a plurality of replaceable cleaning heads configured to scrub a plurality of teeth and gum surfaces simultaneously, and each toothbrush being configured to movably engage and interlock the other according to principles of the invention; and

FIG. 6 is a side view of an exemplary pair of toothbrushes, each having a plurality of replaceable cleaning heads configured to scrub a plurality of teeth and gum surfaces simultaneously, and each toothbrush being configured to movably engage and interlock the other according to principles of the invention; and

FIG. 7 is a top view of an exemplary pair of toothbrushes, each having a plurality of replaceable cleaning heads configured to scrub a plurality of teeth and gum surfaces simultaneously, and each toothbrush being configured to movably engage and interlock the other according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the types of bristles, handle configuration, shapes, relative sizes, ornamental aspects or proportions shown in the figures.

### DETAILED DESCRIPTION

As used herein, the term “oral surfaces” broadly means all surfaces of and relating to the mouth, including tooth, teeth, tongue, cheeks and gums (i.e., gingiva), with each being an oral surface, and in combination comprising oral surfaces. A plurality of the same type or different types of oral surfaces, such as a plurality of tooth or teeth surfaces, or a tooth and gum surface, for example, comprise oral surfaces.

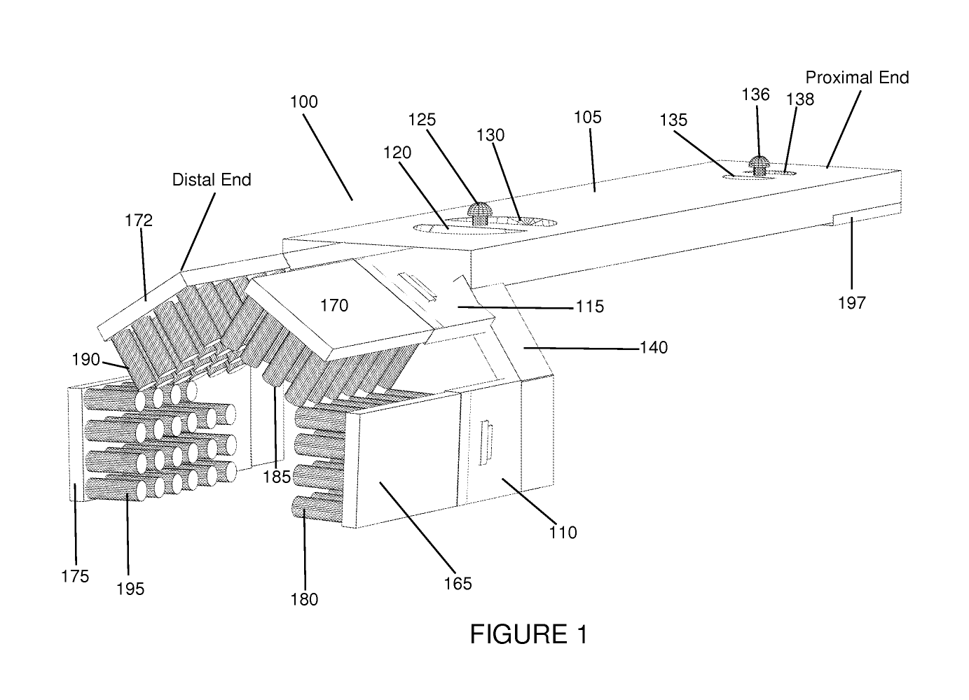

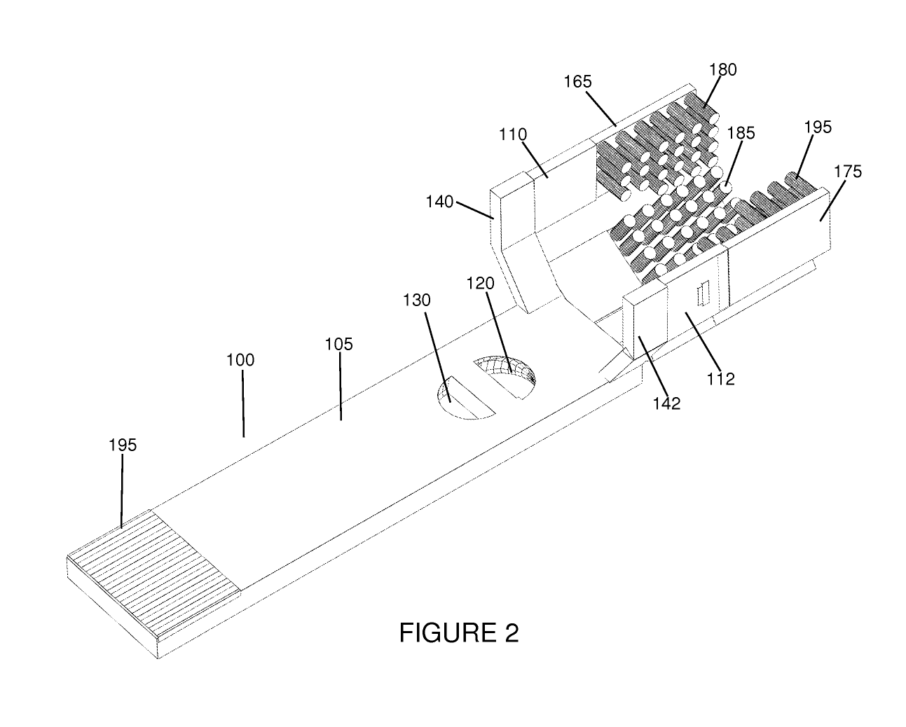

Referring to the Figures, in which like parts are indicated with the same reference numerals, various views of exemplary toothbrushing devices according to principles of the invention are shown. Top and bottom perspective views of an exemplary toothbrush having four replaceable cleaning heads configured to scrub a plurality of teeth and gum surfaces simultaneously according to principles of the invention are provided in FIGS. 1 and 2, respectively. The exemplary toothbrush 100 has a handle 105 and a plurality of removable brush heads 165-175, including a removable pair of central brush heads 170, 172 and a pair of opposed removable lateral brush heads 165, 175. The toothbrush heads 165-175 may range in size from very small for young children to larger sizes for older children and adults and come in any of a variety of shapes such as, for example, rectangular, oblong, elliptical, oval, round or another shape.

The toothbrush 100 includes a cleaning assembly comprising plurality of (i.e., more than one) brushing surfaces which may comprise brush heads 165-175. While four brush heads are shown in FIGS. 1 and 2, the invention is not limited to four brush heads. Any plurality of brush heads oriented to simultaneously clean a plurality of teeth and gum surfaces may be utilized and are intended to come within the scope of the invention.

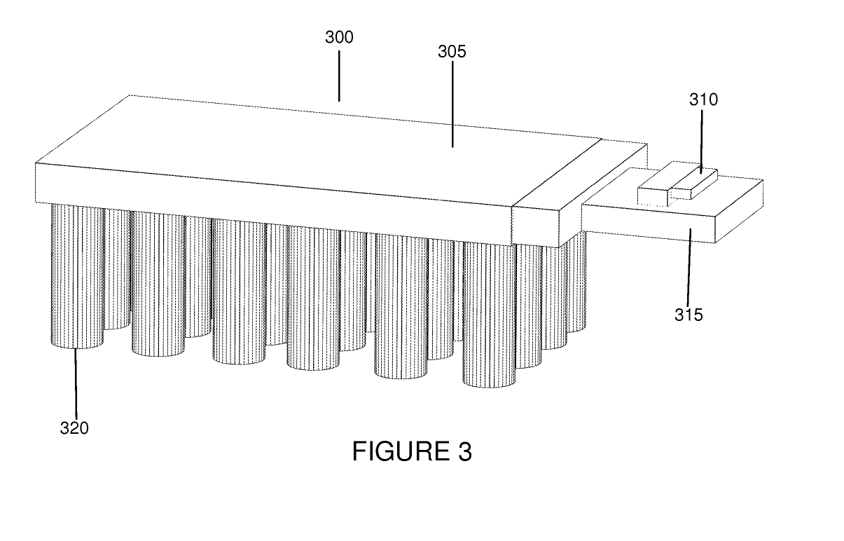

Each brush head 165-175 includes bristles 180-195 attached thereto in a conventional manner. Each brush head 165-175 may have a base 305 (FIG. 3) with a plurality of recesses or holes for receiving bristles 320 (FIG. 3) to form tufts in a conventional manner. Bristles of various sizes, stiffness, configurations and compositions may be utilized and come within the scope of the invention. Cleaning assemblies comprised of cleaning and scrubbing structures other than bristles may be utilized in lieu of or in addition to bristles. By way of example and not limitation, such other cleaning structures may include fibers, microfibers, fabrics, cloth, and any other material suitable for cleaning oral surfaces. The invention is not limited to any particular cleaning media, structure or arrangement thereof.

Means are provided to releasably attach the brush heads 165-175 to the handle 105. In an exemplary embodiment, a coupling 110-120 securely receives a male tenon 315 (FIG. 3) extending from the proximal end of each brush head 165-175 (300 in FIG. 3). A resilient locking tab 310 adapted to engage and project through a corresponding slot in the coupling 110-120 releasably secures the head 300 to the coupling 110-120. Other means for releasably attaching a brush head 165-175 to a corresponding coupling 110-120 may be utilized and are intended to come within the scope of the invention. Such other means may, by way of example and not limitation, may include threaded, snap-fit, twist-lock and other mechanical couplings.

The means for releasably attaching lateral brush heads 165, 175 to the handle 105 may include support arms. A support arm may be an integral part of a coupling or a separate part that is permanently or releasably attached to a coupling. In an exemplary embodiment, a support arm 140, 145 is provided to connect and position each coupling 110, 120 for the lateral brush heads 165, 175 to the toothbrush handle 105. The support arms 140, 145 may be fixedly or releasably attached to the handle 105. The support arms may be formed integrally with the handle and may be flexible. Additionally, the support arms may be adjustable. For example, a support arm 140, 145 of pliant or resilient construction may be utilized. Alternatively, adjustment means, such as adjustment screws, may be utilized to adjust the position and orientation of the support arms, the attached couplings 110, 120, and, thus, the brush heads 165, 175 attached thereto.

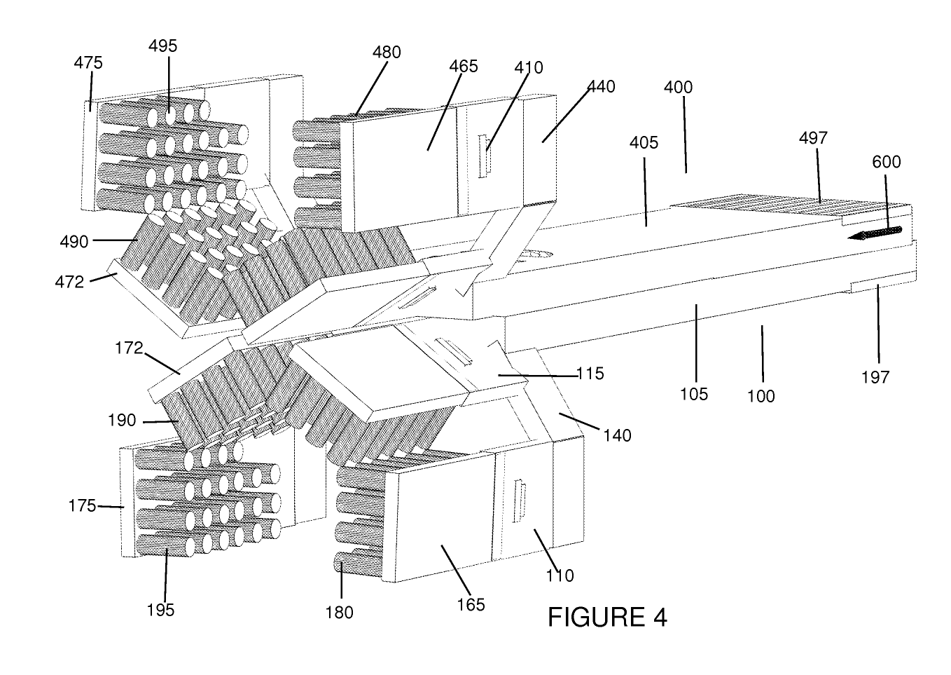

Optionally, a scraper 197 (and 497 in FIG. 4) may be provided at the proximal end ( i.e., end opposite the brush heads 165-175) of the handle 105 on the top, bottom and/or side surfaces thereof. The scraper 197 includes a plurality of raised ridges suitable for scraping the surface of a user's tongue, cheeks and other oral surfaces in conjunction with brushing teeth. The scraper 197 may be comprised of any material suitable for oral scraping, such as, but not limited to, elastomeric and plastic materials.

In an electrical toothbrush embodiment, the toothbrush 100 handle 105 houses an electrically powered actuator such as a transducer or motor or other actuation means. When a switch on the handle is turned on, the actuator is energized by a power supply. The power supply may be utility power or one or more replaceable and/or rechargeable batteries contained within the handle. Various linkages and drive trains may be provided to transmit motion of the actuator to the heads. The switch may have multiple settings and be coupled to circuitry to vary the speed of the actuator. Actuation causes vibratory, reciprocating and/or rotational motion of the brush heads 165-175. The toothbrush 100 may be configured to drive each brush head independently or in unison. The compartment of the handle 105 containing the circuit, actuator and power supply may be completely sealed to prevent water damage. The power supply may be recharged via conductive or inductive charging.

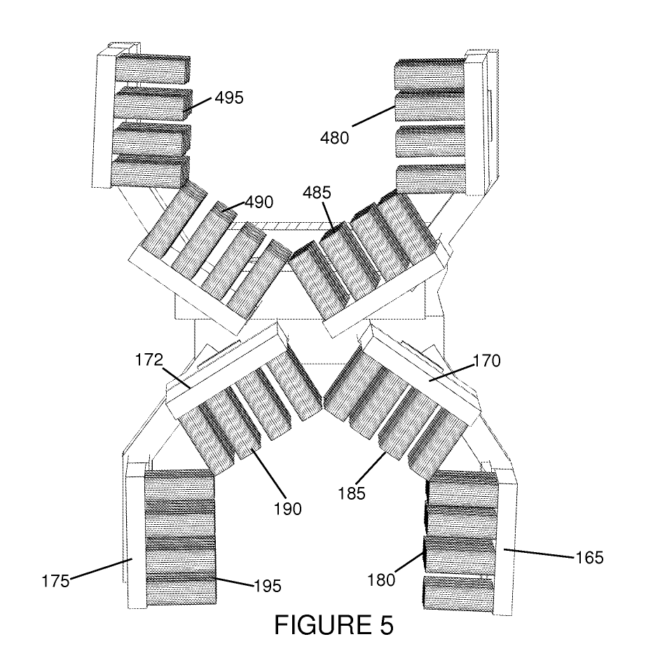

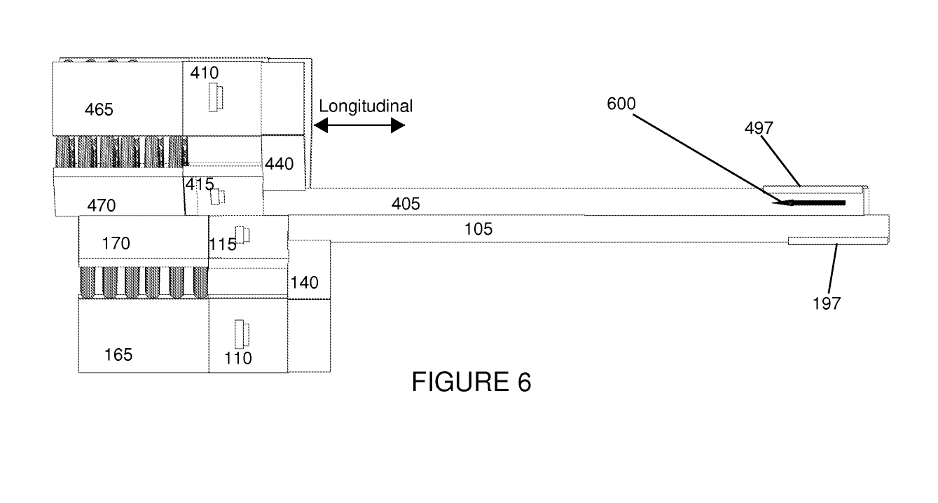

Referring now to FIGS. 4 through 7, a pair of toothbrushes 100, 400, each having four replaceable cleaning heads configured to scrub a plurality of teeth and gum surfaces simultaneously is shown. Each toothbrush 100, 400 is configured to engage and interlock with the other. The assembled toothbrush assembly enables brushing of top and bottom teeth simultaneously. The exemplary toothbrush assembly as shown in FIGS. 6 and 8, has a pair of adjoined handles 105, 405, removable pair of central brush heads 170, 172 and 470, 472 and pairs of opposed removable lateral brush heads 165, 175, 465, 475.

The toothbrush assembly includes a plurality of brush heads 165-175, 665-675 for both the bottom and top teeth. While four brush heads are shown for the bottom and top, the invention is not limited to four brush heads. Any plurality of brush heads oriented to simultaneously clean a plurality of teeth and gum surfaces on the bottom and top may be utilized and are intended to come within the scope of the invention.

Means for releasably attaching lateral brush heads 465, 475 to the handle 405 of the top toothbrush may include support arms. A support arm may be an integral part of a coupling or a separate part that is permanently or releasably attached to a coupling. In an exemplary embodiment, a support arm 440, 445 is provided to connect and position each coupling 410, 420 for the lateral brush heads 465, 475 to the toothbrush handle 405. The support arms 440, 445 may be fixedly or releasably attached to the handle 405. The support arms may be formed integrally with the handle and may be flexible. Additionally, the support arms may be adjustable. For example, a support arm 440, 445 of a pliant construction may be utilized. Alternatively, adjustment means, such as adjustment screws, may be utilized to adjust the position and orientation of the support arms, the attached couplings 410, 420, and, thus, the brush heads 465, 475 attached thereto.

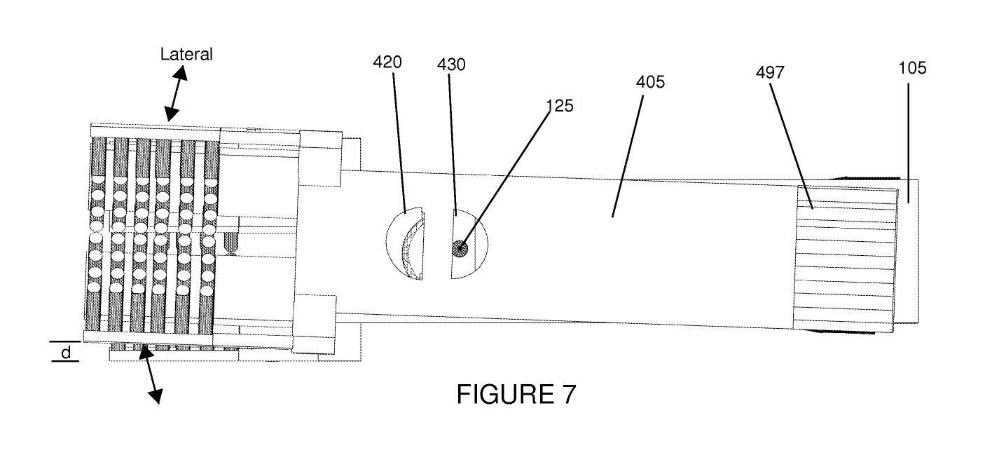

Means are provided to releasably and movably attach the top toothbrush 400 to the bottom toothbrush 100. The attachment mechanism allows movement (e.g., lateral, arcuate and/or pivoting) to properly position the toothbrushes. Proper positioning accommodates occlusion at each side. In an exemplary embodiment, each toothbrush includes a forward pivoting coupling with one or more female apertures 120, 130 on the handle and a corresponding male projection 125 extending from the top of toothbrush. In an exemplary embodiment, each toothbrush also includes a rearward pivoting coupling with one or more female apertures 135, 138 on the handle and a corresponding male projection 136 extending from the top of toothbrush. The forward projection 125 is releasably but securely and movably received by one or more corresponding apertures 120, 130 in the handle of the opposed brush 400. Thus, the projection 125 may move from side to side of the aperture 120, 130 (i.e., laterally as conceptually shown in FIG. 7). Likewise, the rearward projection 136 is securely received by one or more corresponding apertures 135, 138 in the handle of the opposed brush 400. Thus, the projection 136 may move in gliding fashion over a range from side to side of the aperture 135, 138 and anywhere therebetween, as urged by a user. Such movement of the projections 125, 136, which may be arcuate, linear and/or rotational movement, allows positioning of one brush 100 relative to the other brush 400 to accommodate a range of bite patterns and occlusion. Other means for secure, releasable, movable attachment may be utilized and are intended to come within the scope of the invention.

In addition to side-to-side (e.g., lateral) adjustment, the assembly comprising the top toothbrush 400 and bottom toothbrush 100 may be adjusted longitudinally (i.e. forward and backward), as conceptually illustrated in FIG. 6. Longitudinal adjustment facilitates engagement and cleaning of teeth having various bight patterns.

Occlusion refers to the alignment of teeth and the way that the upper and lower teeth fit together (bite). Ideally, all upper teeth fit slightly over the lower teeth; the points of the molars fit the grooves of the opposing molar; all teeth are aligned, straight, and spaced proportionally; and the upper teeth keep the cheeks and lips from being bitten and the lower teeth protect the tongue. To accommodate proper occlusion, in a preferred embodiment, the brush heads 665-675 of the top toothbrush may be positioned to be slightly offset from the brush heads 165-175 of the bottom toothbrush by a determined distance d as shown in FIG. 7. This offset may be accomplished by offset positioning of the means for releasably attaching the top toothbrush 400 to the bottom toothbrush 100, as shown in FIG. 6. The offset may be any length, from zero to the maximum distance allowed by the attachment means. This allows adjustment to accommodate a wide range of alignments, including properly aligned teeth as well as misaligned teeth.

In use, the top toothbrush 400 and bottom toothbrush 100 may be configured to clean a first side of a user's mouth. Then the toothbrushes may be reconfigured to clean another side of the user's mouth. Such configuration and reconfiguration may be accomplished by urging the brushes to into positions relative to one another as suitable for engaging and cleaning the teeth.

A picking device 600 is also provided in an exemplary embodiment. The picking device allows cleaning between teeth and in other cracks and crevasses. The device 600 may be pivotable or reatractable from a closed position substantially flush with the handle 100, 400, to an open extended position.

In another embodiment, any and all of the toothbrush units described above may be foldable, configured for disassembly or otherwise collapsible (collectively referred to herein as collapsing). This would facilitate storage, and is particularly useful for travel. Components such as hinges, joints and other mechanical features that provide means for collapsing may be incorporated or attached to portions of the unit to provide such functionality.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

1. An oral surface cleaning apparatus comprising:
a handle having distal and proximal ends,
a cleaning assembly attached to the distal end of the handle, said cleaning assembly being configured to simultaneously clean a plurality of oral surfaces.

2. An oral surface cleaning apparatus according to claim 1, further comprising:
a releasable attachment, said cleaning assembly being releasably attached to the distal end of the handle by said releasable attachment.

3. An oral surface cleaning apparatus according to claim 1, wherein the cleaning assembly comprises a first plurality of brush heads configured to clean a top row of teeth and gingiva and a second plurality of brush heads configured to clean a bottom row of teeth and gingiva on a same side of a mouth.

4. An oral surface cleaning apparatus according to claim 2, said cleaning assembly comprising at least one brush head releasably attached to the distal end of the handle.

5. An oral surface cleaning apparatus according to claim 2, said cleaning assembly comprising:
at least one central brush head removably attached to the distal end of the handle, and
a first lateral brush head removably attached to the distal end of the handle, a second lateral brush head removably attached to the distal end of the handle, said at least one central brush head being disposed between said first and second lateral brush heads.

6. An oral surface cleaning apparatus according to claim 5, wherein:
the at least one central brush head comprises a pair of central brush heads having a plurality of recesses for receiving bristles, and a plurality of bristles each having an engaged end and a free end, said engaged end of each of said plurality of bristles being received in said plurality of recesses.

7. An oral surface cleaning apparatus according to claim 1, wherein the cleaning assembly attached to the distal end of the handle comprises four brush heads oriented to simultaneously clean a plurality of oral surfaces.

8. An oral surface cleaning apparatus according to claim 1, further comprising an oral surface scraper, said scraper being attached near the distal end of the handle.

9. An oral surface cleaning apparatus according to claim 1, further comprising a retractable pick operably coupled to said handle.

10. An oral surface cleaning apparatus according to claim 1, wherein the handle houses an electrically powered actuator operably configured to cause motion of the cleaning assembly.

11. An oral surface cleaning apparatus according to claim 1, further comprising a means for collapsing said apparatus.

12. An oral surface cleaning apparatus comprising:
a first cleaning implement comprising a first handle having distal and proximal ends an attachment, a first cleaning assembly attached to the distal end of the handle, said first cleaning assembly being configured to simultaneously clean a plurality of oral surfaces, and
means for attaching the first cleaning implement to another cleaning implement.

13. An oral surface cleaning apparatus according to claim 12, further comprising a second cleaning implement comprising a second handle having distal and proximal ends, a second cleaning assembly attached to the distal end of the handle, said second cleaning assembly being configured to simultaneously clean a plurality of oral surfaces, and
means for attaching the second cleaning implement to the first cleaning implement.

14. An oral surface cleaning apparatus according to claim 13, further comprising a first releasable attachment configured for releasably attaching said first cleaning assembly to the distal end of the handle of the first implement, and a second releasable attachment configured for releasably attaching said second cleaning assembly to the distal end of the handle of the second implement, wherein said first cleaning assembly is releasably attached to the handle of the first implement, and said second cleaning assembly is releasably attached to the handle of the second implement.

15. An oral surface cleaning apparatus according to claim 13, said first cleaning assembly comprising at least one brush head releasably attached to the distal end of the first handle; said second cleaning assembly comprising at least one brush head releasably attached to the distal end of the second handle.

16. An oral surface cleaning apparatus according to claim 13, wherein the means for releasably attaching the first cleaning implement comprises a forward pivoting coupling having a forward female aperture and a corresponding forward male projection, and a rearward pivoting coupling having a rearward female aperture and a corresponding rearward male projection, said forward pivoting coupling being disposed on said handle between the distal end and the rearward pivoting coupling, and said rearward pivoting coupling being disposed on said handle between the proximal end and the forward pivoting coupling.

17. An oral surface cleaning apparatus according to claim 16, wherein:
the means for releasably attaching the first cleaning implement and the means for releasably attaching the second cleaning implement are configured to engage each other with said forward male projection of the second implement engaging the forward female aperture of the first implement, and said forward male projection of the first implement engaging the forward female aperture of the second implement, and said rearward male projection of the second implement engaging the rearward female aperture of the first implement, and said rearward male projection of the first implement engaging the rearward female aperture of the second implement.

18. An oral surface cleaning apparatus according to claim 13, wherein the means for releasably attaching the first cleaning implement comprises a forward coupling having a plurality of forward female apertures and a corresponding forward male projection, and a rearward coupling having a plurality of rearward female apertures and a corresponding rearward male projection, said forward coupling being disposed on said handle between the distal end and the rearward pivoting coupling, and said rearward coupling being disposed on said handle between the proximal end and the forward pivoting coupling; wherein the means for releasably attaching the first cleaning implement and the means for releasably attaching the second cleaning implement are configured to engage each other with the forward male projection of the second implement engaging one of the plurality of forward female apertures of the first implement, and said forward male projection of the first implement engaging one of the plurality of forward female apertures of the second implement, and said rearward male projection of the second implement engaging one of the plurality of rearward female apertures of the first implement, and said rearward male projection of the first implement engaging one of the plurality of rearward female apertures of the second implement, and said means for releasably attaching the first cleaning implement and the means for releasably attaching the second cleaning implement are configured to allow longitudinal adjustment of the first implement relative to the second implement.

19. An oral surface cleaning apparatus according to claim 16, wherein the means for releasably attaching the first cleaning implement and the means for releasably attaching the second cleaning implement are configured to engage each other with said forward male projection of the second implement engaging the forward female aperture of the first implement, and said forward male projection of the first implement engaging the forward female aperture of the second implement, and said rearward male projection of the second implement engaging the rearward female aperture of the first implement, and said rearward male projection of the first implement engaging the rearward female aperture of the second implement, and said means for releasably attaching the first cleaning implement and the means for releasably attaching the second cleaning implement are configured to allow lateral movement of the first implement relative to the second implement when the first implement is releasably attached to the second implement.

20. An oral surface cleaning apparatus according to claim 16, wherein the means for releasably attaching the first cleaning implement and the means for releasably attaching the second cleaning implement are configured to engage each other with said forward male projection of the second implement engaging the forward female aperture of the first implement, and said forward male projection of the first implement engaging the forward female aperture of the second implement, and said rearward male projection of the second implement engaging the rearward female aperture of the first implement, and said rearward male projection of the first implement engaging the rearward female aperture of the second implement, and said means for releasably attaching the first cleaning implement and the means for releasably attaching the second cleaning implement are configured to allow pivotal movement of the first implement relative to the second implement when the first implement is releasably attached to the second implement.

21. An oral surface cleaning apparatus according to claim 16, wherein the means for releasably attaching the first cleaning implement and the means for releasably attaching the second cleaning implement are configured to engage each other with said forward male projection of the second implement engaging the forward female aperture of the first implement, and said forward male projection of the first implement engaging the forward female aperture of the second implement, and said rearward male projection of the second implement engaging the rearward female aperture of the first implement, and said rearward male projection of the first implement engaging the rearward female aperture of the second implement, and said means for releasably attaching the first cleaning implement and the means for releasably attaching the second cleaning implement are configured to allow movement of the first implement relative to the second implement to accommodate a range of bite patterns and occlusion.

22. An oral surface cleaning apparatus according to claim 12, further comprising an oral surface scraper, said scraper being attached near the distal end of the handle of the first implement.

23. An oral surface cleaning apparatus according to claim 12, further comprising a retractable pick operably coupled to said handle of the first implement.

24. An oral surface cleaning apparatus according to claim 13,
said first cleaning assembly being configured to simultaneously clean a plurality of oral surfaces including oral surfaces of the top row of teeth, while said second cleaning assembly is configured to simultaneously clean a plurality of oral surfaces including oral surfaces of the bottom row of teeth.

25. An oral surface cleaning apparatus according to claim 12, further comprising a means for collapsing said apparatus.

26. An oral surface cleaning apparatus according to claim 12 wherein the handle houses an electrically powered actuator operably configured to cause motion of the cleaning assembly.
